(19) United States
(12) Patent Application Publication
(10) Pub. No.: US 2006/0078282 A1
(43) Pub. Date: Apr. 13, 2006

(54) Information processing apparatus, method of controlling its external appliances and a television broadcast receiver

(75) Inventors: Akira Miyazawa, Saitama-shi (JP); Kenji Matsumoto, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/234,122

(22) Filed: Sep. 26, 2005

(30) Foreign Application Priority Data
Sep. 27, 2004 (JP) 2004-280480

(51) Int. Cl. H04N 5/76; H04N 5/783

(52) U.S. Cl. 386/46; 386/83; 386/68

(57) ABSTRACT

An information processing apparatus previously grasps a function of an information recording/reproducing apparatus externally connected via a network when a connection is made. When the information recording/reproducing apparatus is in a recording state, the apparatus instructs the information recording/reproducing apparatus to reproduce recorded information in response to an instruction input of time shift reproduction of reproducing the recorded information.

### CROSS-REFERENCE TO RELATED APPLICATIONS

This application is based upon and claims the benefit of priority from prior Japanese Patent Application No. 2004-280480, filed Sep. 27, 2004, the entire contents of which are incorporated herein by reference.

### BACKGROUND OF THE INVENTION

1. Field of the Invention

The present invention relates to an information processing apparatus and a television broadcast receiver such as a digital television receiver, which enables an external connection with a video recording/reproducing apparatus capable of recording/reproducing a program. Moreover, the present invention relates to a method of controlling external appliances when the video recording/reproducing apparatus has a so-called time shift reproduction function.

2. Description of the Related Art

As known, digitization of television broadcasting has been promoted in recent years. For example, in Japan, terrestrial digital broadcasting has started in addition to satellite digital broadcasting such as BS (Broadcasting Satellite) and 110-degree CS (communication Satellite) digital broadcasting.

A digital broadcasting receiver receiving the foregoing digital television broadcasting is externally connected with mass-storage digital recording/reproducing appliances such as an HDD (Hard Disk Drive) and DVD (Digital Versatile Disk). By doing so, the digital broadcasting receiver can digitally record the received programs and reproduce the recorded programs. In addition, there is provided a value-added apparatus having a function of accessing and using video appliances via a network.

As described above, the digital broadcasting receiver is connectable with various video appliances via various interfaces. Appliance and content are successively selected with respect to several appliances externally connected, and thereby, an arbitrary appliance can record or reproduce a desired content.

On the other hand, an advanced HDD/DVD recorder has a so-called time shift reproduction function of reproducing recording contents and monitoring it. The function has no influence in particular on usability so long as the recorder side controls the function. However, there is a problem in the following case. More specifically, a connection with the foregoing digital broadcasting receiver is made, and thereafter, the receiver side controls the recorder. In this case, the appliance and content must be successively selected as described above; for this reason, a user inevitably performs troublesome operations. In the time shift reproduction function built in the HDD/DVD recorder, users require to reproduce the recording program soon. For this reason, the foregoing troublesome operations are highly unpopular among the users.

Incidentally, an outline of the technique relevant to the foregoing time shift reproduction has been disclosed in JPN. PAT. APPLN. KOKAI Publications No. 2004-048525 and 2004-207975. However, the Publications do not disclose the configuration for controlling externally connected recording/reproducing appliances so that a receiver side makes a time shift reproduction.

### BRIEF SUMMARY OF THE INVENTION

An object of the present invention is to provide an information processing apparatus, a method of controlling an external appliance and a television broadcast receiver, which can carry out control so that externally connected recording/reproducing appliances reproduce recording information with a simple operation.

According to a first aspect of the present invention, there is provided an information processing apparatus comprising: a connector connectable to an external information recording/reproducing apparatus;
a controller determining whether or not the information recording/reproducing apparatus is recording information; and a reproduction instructor instructing the information recording/reproducing apparatus to reproduce recorded information by a time shift reproducing mode in response to an instruction input in a state that the controller determines that the information recording/reproducing apparatus is recording information.

According to a second aspect of the present invention, there is provided a method of controlling an external appliance of an information processing apparatus, comprising: a determination process of determining whether or not an information recording/reproducing apparatus externally connected is recording information; and a reproduction instruction process of instructing the information recording/reproducing apparatus to reproduce recorded information by a time shift reproducing mode in response to an instruction input in a state that the controller determinates that the information recording/reproducing apparatus is recording information.

According to a third aspect of the present invention, there is provided a television broadcast receiver comprising: an external connector for making an external connection of a recording/reproducing apparatus; a tuner tuning a television broadcast signal; a demodulator demodulating a content of a broadcasting program from the television broadcast signal tuned by the tuner; a controller determining whether or not the information recording/reproducing apparatus is recording information; and a reproduction instructor instructing the recording/reproducing apparatus to reproduce a recorded content by a time shift reproducing mode in response to an instruction input in a state that the controller determines that the recording/reproducing apparatus is recording information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view to schematically explain a digital television broadcasting receiver according to an embodiment of the present invention and a network system configured using the receiver as the host;

FIG. 2 is a block diagram to explain principal signal processing systems of the digital television broadcasting receiver shown in FIG. 1;

FIG. 3 is an appearance view to explain a remote controller of the digital television broadcasting receiver shown in FIG. 1;

FIG. 4 is a flowchart to explain the operation procedure of setting designated program reservation with respect to the digital television broadcasting receiver shown in FIG. 1;

FIG. 5A, FIG. 5B and FIG. 5C are views to explain various setup screens when setting the designated program reservation with respect to the digital television broadcasting receiver shown in FIG. 1;

FIG. 6 is a view showing a display example of a quick menu in the digital television broadcasting receiver shown in FIG. 1; and

FIG. 7 is a flowchart to explain a time shift reproduction function of externally connected appliances in the digital television broadcasting receiver shown in FIG. 1.

### DETAILED DESCRIPTION OF THE INVENTION

An embodiment of the present invention will be described below with reference to the accompanying drawings.

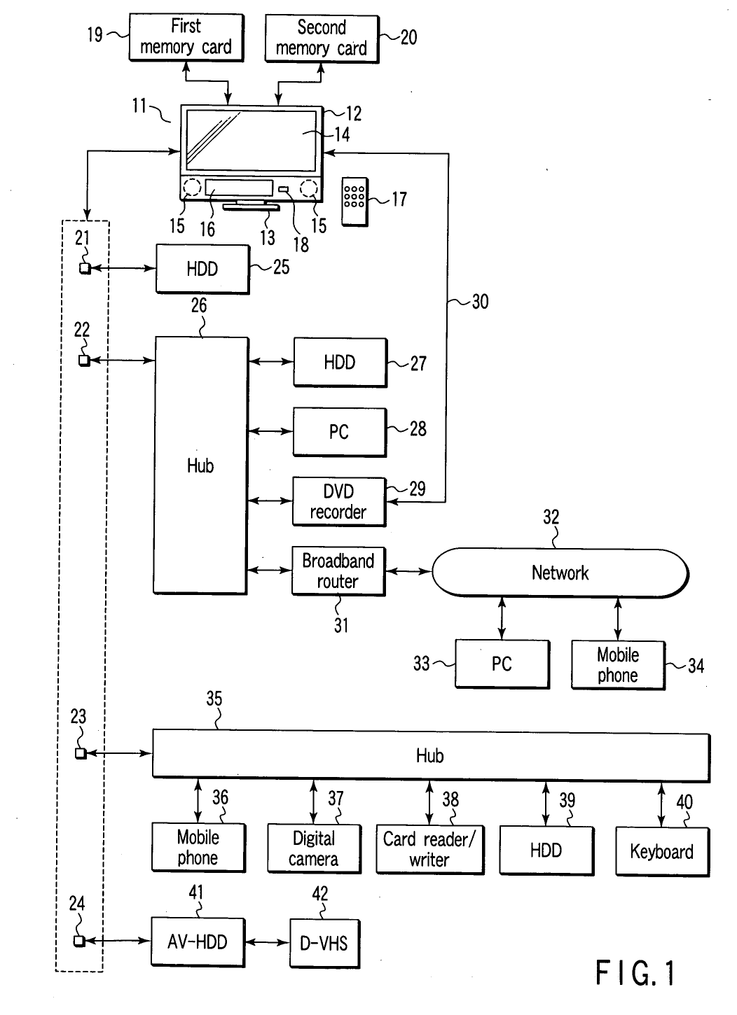

FIG. 1 schematically shows the appearance of a digital television broadcasting receiver 11 according to this embodiment and a network system configured using the receiver 11 as the host.

The digital television broadcasting receiver 11 is mainly composed of a thin cabinet 12 and a support plate 13 for standing and supporting the cabinet 12. The cabinet 12 is provided with flat-panel video display 14 comprising liquid crystal display panel, speaker 15, operation section 16 and light receiving section 18. The light receiving section 18 receives operation information sent from a remote controller 17.

The receiver 11 is removably loaded with a first memory card 19 such as an SD (Secure Digital) memory card, MMC (Multimedia Card) and memory stick. Recording and reproduction of information such as programs and photographs are made with respect to the first memory card 19.

Moreover, the receiver 11 is removably loaded with a second memory card (IC card) 20, which records contract information. Recording and reproduction of information are made with respect to the second memory card 20.

Furthermore, the receiver 11 includes first LAN (Local Area Network) terminal 21, second LAN terminal 22, USB (Universal Serial Bus) terminal 23 and i.Link terminal 24.

The first LAN terminal 21 is used as a LAN-enabled HDD dedicated port. More specifically, the first LAN terminal 21 is used for making information recording and reproduction with respect to a connected NAS (Network Attached Storage), that is, LAN-enabled HDD 25 via Ethernet (registered trademark of Xerox Corporation).

As described above, the receiver 11 is provided with the first LAN terminal 21 as a LAN-enabled HDD dedicated port. By doing so, information recording of Hi-Vision image programs is stably made with respect to the HDD 25 without being influenced by other network environments and network availability conditions.

The second LAN terminal 22 is used as a general LAN-enabled port using Ethernet (registered trademark of Xerox Corporation). For example, the terminal 22 makes a connection with the appliances given below via a hub 26, and is used to make information transmission with those appliances. The foregoing appliances are LAN-enabled HDD 27, PC (Personal Computer) 28 and DVD (Digital Versatile Disk) recorder 29 having a built-in HDD.

In the DVD recorder 29, digital information communicated via the terminal 22 is control system information only. For this reason, a dedicated analog transmission line 30 must be provided to transmit analog video and voice information between the DVD recorder 29 and the receiver 11.

Moreover, the foregoing second LAN terminal 22 makes a connection with a network 32 such as the Internet via a broadband router 31 connected to the hub 26. The terminal is used to make information transmission with PC 33 and mobile phone 34 via the network 32.

The USB terminal 23 is used as a general USB-enabled port. The terminal 23 makes a connection with the USB appliances given below via a hub 35, and is used to make information transmission with those USB appliances. The USB appliances are mobile phone 36, digital camera 37, card reader/writer 38 with respect to memory card, HDD 39 and keyboard 40.

The i.Link terminal 24 serially connects AV-HDD 41, D (Digital)-VHS (Video Home System) 42, and is used to make information transmission with those USB appliances.

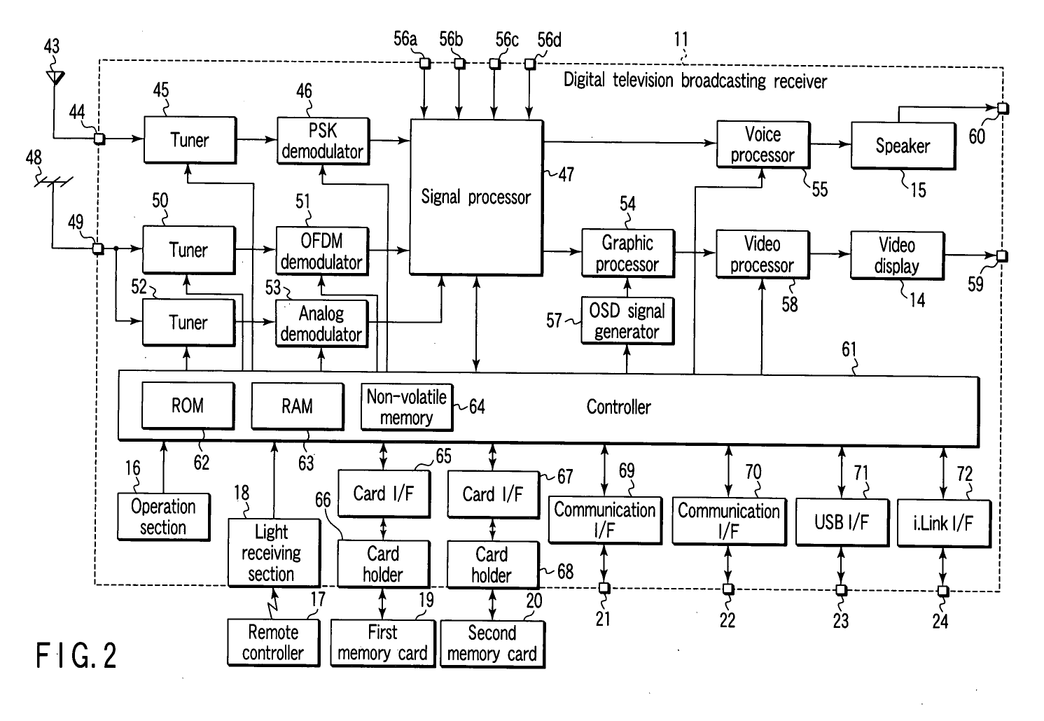

FIG. 2 is a block diagram to explain principal signal processing systems of the digital television broadcasting receiver 11. More specifically, a BS/CS digital broadcasting receiving antenna 43 receives a satellite digital vision broadcasting signal. The received broadcasting signal is supplied to a satellite digital broadcasting tuner 45, and thereby, a desired channel broadcasting signal is tuned.

The broadcasting signal tuned by the tuner 45 is supplied to a PSK (Phase Shift Keying) demodulator 46. Then, the broadcasting signal is demodulated into digital video signal and voice signal, and thereafter, outputted to a signal processor 47.

A terrestrial broadcasting receiving antenna 48 receives a terrestrial digital television broadcasting signal. The received broadcasting signal is supplied to a terrestrial digital broadcasting tuner 50 via an input terminal 49, and thereby, a desired channel broadcasting signal is tuned.

The broadcasting signal tuned by the tuner 50 is supplied to an OFDM (Orthogonal Frequency division Multiplexing) demodulator 51. Then, the broadcasting signal is demodulated into a digital video signal and voice signal, and thereafter, outputted to the signal processor 47.

On the other hand, the terrestrial broadcasting receiving antenna 48 receives a terrestrial analog television broadcasting signal. The received broadcasting signal is supplied to a terrestrial analog broadcasting tuner 52 via the input terminal 49, and thereby, a desired channel broadcasting signal is tuned. The broadcasting signal tuned by the tuner 52 is supplied to an analog demodulator 53. Then, the broadcasting signal is demodulated into digital video signal and voice signal, and thereafter, outputted to the signal processor 47.

The signal processor 47 selectively converts digital video signal and voice signal supplied respectively from PSK demodulator 46 and OFDM demodulator 51 into a predetermined digital signal. Thereafter, the signal processor 47 outputs the signal to graphic processor 54 and voice processor 55.

The signal processor 47 is further connected with several (four in FIG. 2) input terminals 56a to 56d. The input terminals 56a to 56d are used to input an analog video signal and voice signal from the exterior of the receiver 11.

The signal processor 47 selectively digitizes the analog video signal and voice signal supplied respectively from analog demodulator 53 and input terminals 56a to 56d. Then, the signal processor 47 converts the digitized video signal and voice signal into a predetermined digital signal, and thereafter, outputs it to graphic processor 54 and voice processor 55.

The graphic processor 54 has a function of overlapping the digital video signal supplied from the signal processor 47 with an OSD signal generated by an OSD (On Screen Display) signal generator 57, and outputting the overlapped signal. The graphic processor 54 selectively outputs an output video signal of the signal processor 47 and an output OSD signal of the OSD generator 57. In addition, the graphic processor 54 outputs the foregoing two outputs so that each output is reflected on half of a screen.

The digital video signal outputted from the graphic processor 54 is supplied to a video processor 58. The video processor 58 converts the inputted digital video signal into an analog video signal having a format displayable by the video display 14, and arbitrarily adjusts a display color. Thereafter, the video processor 58 outputs the video signal so that the video display 14 displays a video image, and leads it to the outside via an output terminal 59. The video processor 58 performs color management under the control by a controller 61 in response to instructions from the remote controller 17. In addition, the video processor 58 is operable in automatic color management mode and manual management mode adjustable by user's favorite.

The voice processor 55 converts the inputted digital voice signal into an analog voice signal having a format reproducible by the speaker 15. Thereafter, the voice processor 55 outputs the voice signal so that the speaker 15 reproduces the voice, and leads it to the outside via an output terminal 60.

In the digital television broadcasting receiver 11, the controller 61 collectively controls the entire operations including the foregoing various receiving operations. The controller 61 has a built-in CPU (Central Processing Unit). The controller 61 receives operations from the operation section 16 or receives information sent from the remote controller 17 via the light receiving section 18. By doing so, the controller 61 controls processors and sections so that operation contents are reflected.

In this case, the controller 61 mainly uses ROM (Read Only Memory) 62, RAM (Random Access Memory) 63 and non-volatile memory 64, which are described below. The ROM 62 is stored with control programs executed by the CPU. The RAM 63 provides a work area for the CPU. The non-volatile memory 64 is stored with various setting information and control information.

The controller 61 is connected with a card holder 66 capable of loading the first memory card 19 via a card I/F (Interface) 65. By doing so, the controller 61 makes information transmission with the first memory card 19 loaded in the card holder 66 via the card I/F 65.

Moreover, the controller 61 is connected with a card holder 68 capable of loading the second memory card 20 via a card I/F (Interface) 67. By doing so, the controller 61 makes information transmission with the second memory card 20 loaded in the card holder 66 via the card I/F 67.

The controller 61 is connected with the first LAN terminal 21 via a communication I/F 69. By doing so, the controller 61 makes information transmission with the LAN-enabled HDD 25 connected to the first LAN terminal 21 via the communication I/F 69. In this case, the controller 61 has a DHCP (Dynamic Host Configuration Protocol) server function. The controller 61 executes control to allocate an IP (Internet Protocol) address to the LAN-enabled HDD 25 connected to the first LAN terminal 21.

The controller 61 is connected with the second LAN terminal 22 via a communication I/F 70. By doing so, the controller 61 makes information transmission with various appliances (see FIG. 1) connected to the second LAN terminal 22 via the communication I/F 70.

The controller 61 is connected with the USB terminal 23 via a USB I/F 71. By doing so, the controller 61 makes information transmission with various appliances (see FIG. 1) connected to the USB terminal 23 via the USB I/F 71.

The controller 61 is connected with the i.Link terminal 24 via an i.Link I/F 72. By doing so, the controller 61 makes information transmission with various appliances (see FIG. 1) connected to the i.Link terminal 24 via the i.Link I/F 72.

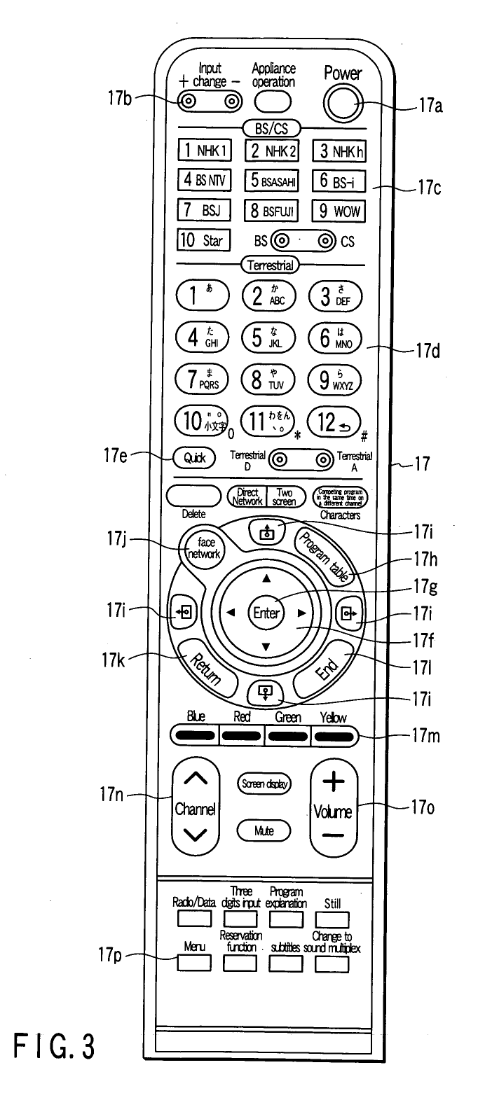

FIG. 3 shows the appearance of the remote controller 17. The remote controller 17 is mainly provided with power key 17a, input change key 17b, satellite digital broadcasting channel direct tuning keys 17c, terrestrial digital broadcasting channel direct tuning keys 17d. Moreover, the remote controller 17 includes quick key 17e, cursor key 17f, enter key 17g, program table key 17h, page change key 17i, face net (navigation) key 17j. In addition, the remote controller 17 includes return key 17k, end key 17l, blue, red, green and yellow color keys 17m, channel up-down key 17n, volume control key 17o and menu keys 17p.

As described above, the receiver 11 includes card holders 66 and 68 for loading the first and second memory cards 19 and 20, and the following terminals. One is the first LAN terminal 21 for NAS connection, and another is the second LAN terminal 22 for connecting general network-enabled video appliances. Another is the USB (Universal Serial Bus) terminal 23 for connecting various video appliances, and another is the i.Link terminal 24. The controller 61 controls the connection state of the foregoing holders and terminals. If video appliances are connected to these holders or terminals, connection information is manually or automatically set and registered in the non-volatile memory 64 of the controller 61. In this case, the connection information shows “what” is connected to “where” and “when”.

The following is a description of a reservation function included in the digital television broadcasting receiver 11. The reservation function is classified into two kinds, that is, program designated reservation and date/time-designated reservation. According to the program-designated reservation, a planned broadcasting program is designated and reserved. According to the date/time-designated reservation, channel and date/time are designated and reserved. The program-designated reservation has recording reservation and TV viewing reservation. According to the recording reservation, a designated program is recorded to a designated recorder or recording medium such as a memory card. According to the TV viewing reservation, a designated program is only tuned. The date/time-designated reservation has recording reservation and TV viewing reservation. According to the recording reservation, broadcasting contents of designated channel and date/time are recorded to a designated recorder or recording medium such as a memory card. According to the TV viewing reservation, the broadcasting of a designated channel and date/time is only tuned. For simplification of explanation, the designated-program reservation will be described below; in this case, the designated-date/time reservation is carried out in the same manner.

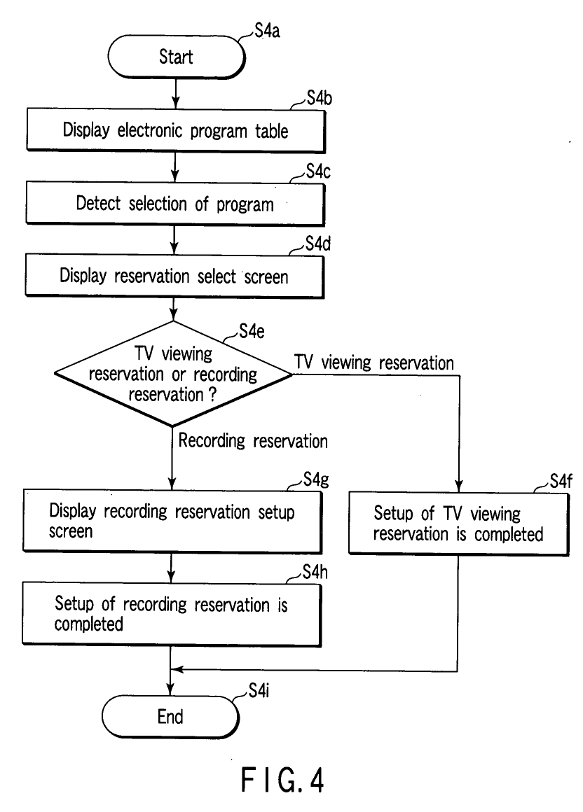

FIG. 4 is a flowchart to explain the operation procedure of setting the designated-program reservation to the digital television broadcasting receiver 11. The operation is started when the user operates the program table key 17h using the remote controller 17 (step S4a).

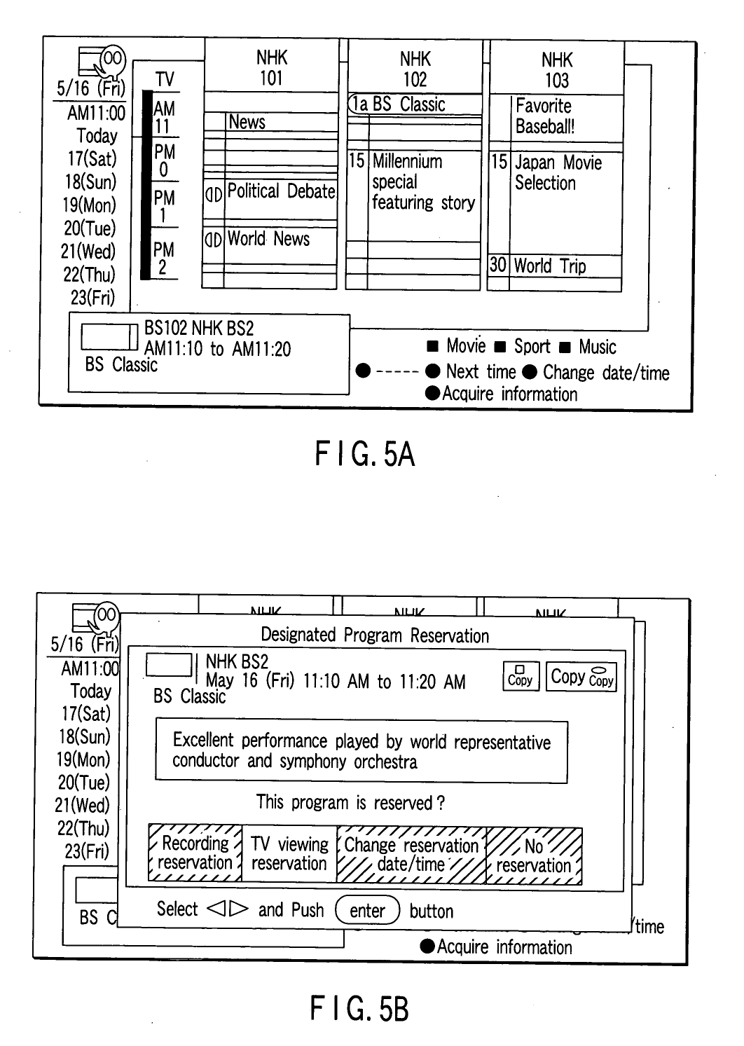

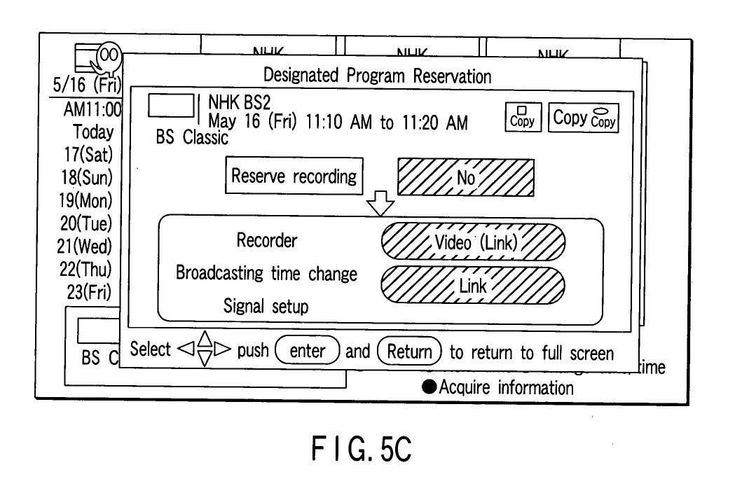

In step S4b, the controller 61 controls the video display 14 so that an electronic program table shown in FIG. 5A is displayed based on an EPG (Electronic Program Guide) previously acquired from a broadcasting signal.

By doing so, the user can select a desired program from the electronic program table. More specifically, the user operates the cursor key 17f of the remote controller 17 to select a desired program, and then, operates the enter key 17g, and thereby, the selection is completed.

When making detection that the desired program is selected and set from the electronic program table in step S4c, the controller 61 displays a reservation select screen shown in FIG. 5B in step S4d.

On the reservation select screen, schematic explanations such as broadcasting channel, date and contents relevant to the selected program are displayed. Thereafter, the user selects recording reservation or TV viewing reservation. In either case, the user operates the cursor key 17f of the remote controller 17 to select recording reservation or TV viewing reservation, and then, operates the enter key 17g, and thereby, the selection is made.

The controller 61 determines in step S4e whether either of the recording reservation or the TV viewing reservation is selected. If it is determined that the TV viewing reservation is selected, the controller 61 stores various information set for the TV viewing reservation in step 4f in the non-volatile memory 64. The TV viewing reservation setting is completed, and then, the procedure ends (step S4i). The TV viewing reservation is set, and thereby, the selected program is automatically tuned to view the TV program.

On the other hand, if it is determined in step 4e that the recording reservation TV is selected, the controller 61 displays a recording reservation setup screen shown in FIG. 5C in step S4g. Using the recording reservation setup screen, the user selects whether or not recording reservation of the selected program is made while designating a digital recorder or recording medium for recording the selected program.

If various items required for the recording reservation are set on the recording reservation setup screen, the controller 61 stores various information set for the recording reservation in step 4h in the non-volatile memory 64. The recording reservation setting is completed, and then, the procedure ends (step S4i). The recording reservation is set, and thereby, the selected program is automatically recorded to a designated digital recorder or recording medium.

The following is a description of features of the present invention, that is, the method of controlling externally connected appliances in the receiver having the configuration described above. The following case is given as one example. More specifically, the LAN-enabled HDD 27 connected to the second LAN terminal 22 via the hub 26 has a time shift reproduction function. The receiver 11 designates the HDD 27 to reserve program recording, and makes the time shift reproduction after recording starts.

The function of the externally connected appliances is registered in the non-volatile memory 64 of the controller 61 shown in FIG. 2 in connection setup together with appliance identification information and recording position (path) information.

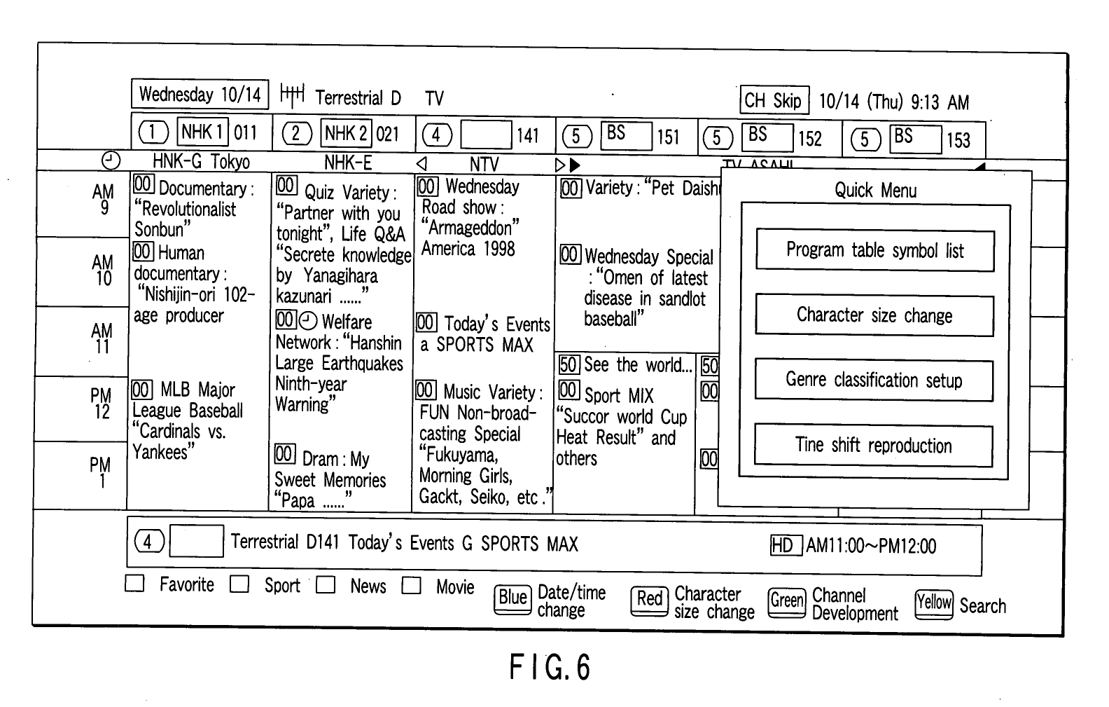

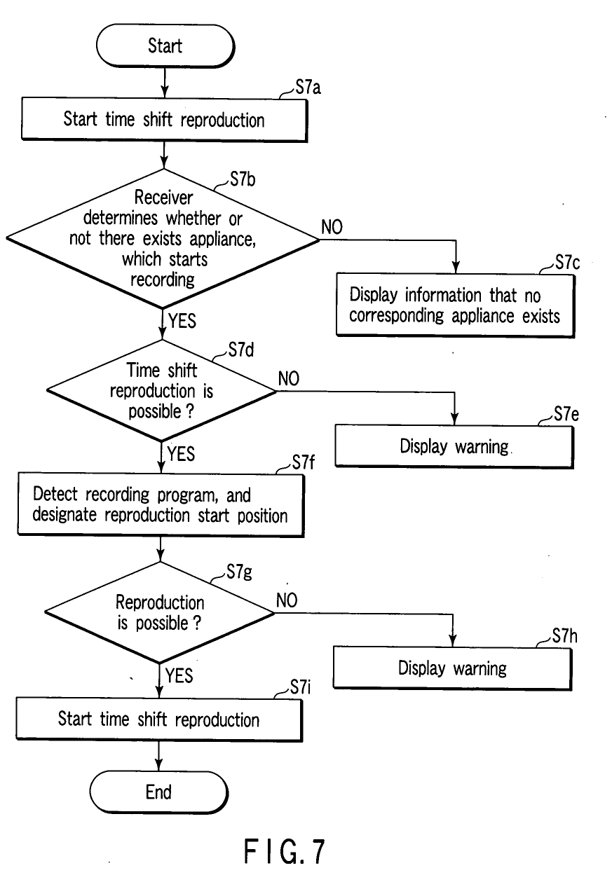

The receiver 11 is equipped with a time shift reproduction function on the assumption that the user designates the HDD 27 to reserve a received program recording, and desires to view the program from the beginning after recording starts. As seen from FIG. 6, the time shift reproduction function is one of select items included in a quick menu display on the screen in response to the on-operation of the quick button 17e of the remote controller 17. The user selects the time shift reproduction item in the menu using the cursor 17b of the remote controller 17, and pushes (operates) the enter key 17g. By doing so, the time shift reproduction is carried out according to the procedure shown in FIG. 7.

The time shift reproduction starts up according to the cursor operation of the remote controller 17 (step S7a). In this case, the receiver 11 determines whether or not there exists appliance which starts recording in a state that recording reservation is made (step S7b). If there exists no appliance making recording reservation, the information is displayed (step S7c).

If the corresponding appliance exists, it is determined whether or not the corresponding appliance has a time shift reproduction function (step S7d). If the appliance does not have the function, a warning is displayed (step S7e).

If the corresponding appliance has the time shift reproduction function, a recording program is detected, and then, a reproduction start position is designated (step S7f). The reproduction start includes position before x minute (designate and input x) after the recording start position, position just after recording, etc.

If the reproduction start position of the recording program is designated, it is determined whether or not the program is reproducible from the designated position (step S7g). In other words, the program is not necessarily reproduced during recording depending on the performance of appliance and data recording state. In the recent NAS, if the recording program is a Hi-Vision broadcasting program, decoding is not sufficiently achieved; for this reason, it is impossible to perform time shift reproduction.

As seen from the foregoing explanation, it is determined whether or not reproduction is possible before the time shift reproduction starts. If the reproduction is not made, a warning is displayed (step S7h). If the reproduction is possible, reproduction from the designated position is instructed. Then, the receiver receives a reproduction signal from the corresponding appliance to execute time shift reproduction of the recording program (step S7i).

Therefore, the digital television broadcasting receiver carries out recording reservation with respect to externally connected appliances. If the corresponding appliance is a time shift reproduction enabled appliance, time shift reproduction is possible from an arbitrary position after recording start. In this case, the receiver dose not start the time shift reproduction after select connected appliance, but takes the following procedure. That is, the receiver selects the recording appliance, and thereafter, determines whether or not the corresponding appliance has time shift reproduction function. If the appliance has the function, it reproduces the recording program from a desired position. Therefore, the user can reproduce the recording program from the desired position without performing troublesome operations. Consequently, the time shift reproduction function of the externally connected appliance is sufficiently performed.

In the foregoing embodiment, LAN-connected external appliances are given as an example. The present invention is applicable to other interface connection such as i.Link connection and USB connection.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus, comprising:
a connector connectable to an external information recording/reproducing apparatus;
a controller determining whether or not the information recording/reproducing apparatus is recording information; and
a reproduction instructor instructing the information recording/reproducing apparatus to reproduce recorded information by a time shift reproducing mode in response to an instruction input in a state that the controller determines that the information recording/reproducing apparatus is recording information.

2. The apparatus according to claim 1, wherein the controller previously determines whether or not the information recording/reproducing apparatus is a type of machine capable of reproducing recorded information by the time shift reproducing mode during recording, and
the reproduction instructor makes a response to the instruction input only when the controller determines that the information recording/reproducing apparatus is a type of machine capable of reproducing recorded information by the time shift reproducing mode during recording.

3. The apparatus according to claim 2, wherein the reproduction instructor issues warning when the controller determines that the information recording/reproducing apparatus is a type of machine incapable of reproducing recorded information by the time shift reproducing mode during recording.

4. The apparatus according to claim 1, further comprising:
connector information management means for acquiring and managing identification information of the information recording/reproducing apparatus connected to the external connector, recording position information and functional information for recording/reproducing,
the controller specifying an information recording/reproducing apparatus, which is given as a determination target, based on the connection information

5. The apparatus according to claim 1, further comprising:
recording reservation means for designating the information recording/reproducing apparatus connected to the external connector to make recording reservation,
the controller designating an information recording/reproducing apparatus making recording reservation by the recording reservation means to determine whether or not the information recording/reproducing apparatus is recording information.

6. A method of controlling a external appliance of an information processing apparatus, comprising:
a determination process of determining whether or not an information recording/reproducing apparatus externally connected is recording information; and
a reproduction instruction process of instructing the information recording/reproducing apparatus to reproduce recorded information by a time shift reproducing mode in response to an instruction input in a state that the controller determinates that the information recording/reproducing apparatus is recording information.

7. The method according to claim 6, wherein the determination process includes a process of previously determining whether or not the information recording/reproducing apparatus is a type of machine capable of reproducing recorded information by the time shift reproducing mode during recording, and
the reproduction instruction process includes a process of making a response to the instruction input only when the controller determines that the information recording/reproducing apparatus is a type of machine capable of reproducing recorded information by the time shift reproducing mode during recording.

8. The method according to claim 7, wherein the reproduction instruction process includes issuing a warning when the controller determines that the information recording/reproducing apparatus is a type of machine incapable of reproducing recorded information by the time shift reproducing mode during recording.

9. The method according to claim 6, further comprising:
a connector information management process of acquiring and managing identification information of the information recording/reproducing apparatus connected to the external connector, recording position information and functional information for recording/reproducing,
the determination process of specifying an information recording/reproducing apparatus, which is given as a determination target, based on the connection information

10. The apparatus according to claim 6, further comprising:
a recording reservation process of designating the information recording/reproducing apparatus connected to the external connector to make recording reservation,
the determination process of designating an information recording/reproducing apparatus making recording reservation by the recording reservation means to determine whether or not the information recording/reproducing apparatus is recording information.

11. A television broadcast receiver comprising:
an external connector for making an external connection of a recording/reproducing apparatus;
a tuner tuning a television broadcast signal;
a demodulator demodulating a content of a broadcasting program from the television broadcast signal tuned by the tuner;
a controller determining whether or not the information recording/reproducing apparatus is recording information; and
a reproduction instructor instructing the recording/reproducing apparatus to reproduce a recorded content by a time shift reproducing mode in response to an instruction input in a state that the controller determines that the recording/reproducing apparatus is recording information.

12. The television broadcast receiver according to claim 11, wherein the controller previously determines whether or not the recording/reproducing apparatus is a type of machine capable of reproducing a recorded content by a time shift reproducing mode, and
the reproduction instructor responses the instruction input only when the controller determines that the recording/reproducing apparatus is a type of machine capable of reproducing the recorded content by the time shift reproducing mode.

13. The television broadcast receiver according to claim 12, wherein the reproduction instructor issues warning when the controller determines that the recording/reproducing apparatus is a type of machine incapable of reproducing recorded information by the time shift reproducing mode during recording.

14. The television broadcast receiver apparatus according to claim 12, further comprising:
connector information management means for acquiring and managing identification information of the recording/reproducing apparatus connected to the external connector, recording position information and functional information for recording/reproducing,
the controller specifying a recording/reproducing apparatus, which is given as a determination target, based on the connection information.

15. The television broadcast receiver according to claim 12, further comprising:
recording reservation means for designating the recording/reproducing apparatus connected to the external connector to make recording reservation of the content,
the controller designating a recording/reproducing apparatus making recording reservation by the recording reservation means to determine whether or not the content is recording.
